(19) United States
(12) Patent Application Publication
(10) Pub. No.: US 2012/0200639 A1
(43) Pub. Date: Aug. 9, 2012

(54) COATING DEVICE AND INKJET RECORDING DEVICE

(76) Inventor: Kensuke TAKADA, Kanagawa (JP)

(21) Appl. No.: 13/367,429

(22) Filed: Feb. 7, 2012

(30) Foreign Application Priority Data
Feb. 8, 2011 (JP) P2011-025198

(51) Int. Cl. B05C 1/04; B41J 2/04

(52) U.S. Cl. 347/54; 118/70

(57) ABSTRACT

Provided are a coating device and an inkjet recording device capable of reliably removing liquid attached to a drum. A process liquid is coated by pressing a coating roller against a surface of paper to be transported by a process liquid coating drum. The process liquid attached to an outer peripheral surface of the process liquid coating drum is removed by a blade coming into contact with the outer peripheral surface of the process liquid coating drum. The blade is separated from the process liquid coating drum by an installation portion of a gripper. The process liquid remaining in the process liquid coating drum during separation is removed by air that is ejected from air nozzles.

### BACKGROUND OF THE INVENTION

1. Field of the Invention

The present invention relates to a coating device and an inkjet recording device and, in particular, to a coating device which coats a predetermined process liquid to paper to be transported by a drum, and an inkjet recording device which records an image on the paper with the process liquid coated thereon by the coating device.

2. Description of the Related Art

When printing on a general-purpose paper (a general-purpose printing paper such as a high-quality paper, a coat paper, and an art paper mainly composed of cellulose) which is not an inkjet-exclusive paper with an inkjet method using water based ink, feathering, bleeding or the like may occur, thereby disabling to print in high-quality. Therefore, in a system (an inkjet general-purpose paper printing system) which prints on the general-purpose paper by the inkjet method, a process liquid having a function of agglutinating the ink on the paper before the drawing is coated (for example, refer to JP2009-285878A etc.).

In the case of performing a borderless printing by the inkjet general-purpose paper printing system, there is also a need to coat the process liquid to the whole surfaces of the paper. Moreover, in order to coat the process liquid to the whole surface of the paper, generally, there is a need to coat the process liquid in a coating width wider than a paper width. For example, when coating the process liquid by a roller, the process liquid is coated by using a coating roller having a width wider than the paper width.

However, when coating the process liquid in the coating width wider than the paper width, there is a problem that the process liquid is also coated to a transport mechanism of the paper. Moreover, there is a problem that the process liquid coated to the transport mechanism is attached to next paper to be printed, thereby decreasing the quality of printing.

Thus, there is a need to remove the process liquid coated to the transport mechanism of the paper before transporting the next paper. To satisfy such needs, for example, in a system that transports the paper by a drum and prints the paper, a blade may be placed to be contacted against an outer peripheral surface of the drum in order to remove the process liquid from the drum (for example, refer to JP 1993-147219A(JP-H05-147219), JP2009-143102A etc.).

### SUMMARY OF THE INVENTION

In a system that transports the paper by the drum and prints the paper, generally, a tip portion of the paper is gripped by a gripper that is provided in the outer peripheral portion of the drum, and the paper is transported.

Since the gripper exists as a concave portion or a convex portion on the outer peripheral surface of the drum, in the case of cleaning the gripper by a blade, there is a need to separate the blade at an installation position thereof.

However, when separating the blade from the drum, there is a problem that the process liquid remains (so-called liquid stagnation) in a portion where the blade is separated.

The present invention has been made in view of such circumstances, and an object of the present invention is to provide a coating device and an inkjet recording device capable of reliably removing liquid attached to the drum.

Means for solving the problem is as mentioned below.

According to a first aspect of the present invention, there is provided a coating device which coats liquid to a surface of a sheet of medium, the apparatus includes a transport part having a drum, a gripping part for gripping a tip of the medium on an outer peripheral surface of the drum, and a drum rotation driving part for rotating the drum, wherein the transporting part transports the medium along a predetermined transport path by gripping the tip of the medium with the gripping part and then by rotating the drum; a coating part that coats the liquid to the surface of the medium that is transported by the transport part; a blade which comes into contact with an outer peripheral surface of the drum in a region other than the transport region and removes the liquid remaining on the outer peripheral surface of the drum; a collection part for collecting the liquid removed from the drum by the blade; a blade advance and retreat driving part for moving the blade back and forth to the drum and bringing the blade into contact with the outer peripheral surface of the drum or separates the blade from the outer peripheral surface of the drum; a blowing part placed in a rear end of the blade in a rotation direction of the drum, blows air toward the drum, and blows down the liquid remaining on the outer peripheral surface of the drum to the collection part when the blade is separated; and a control part for executing a coating process by controlling the operation of the transport part and the coating part, and executes a drum cleaning process by controlling the blade advance and retreat driving part and the blowing part.

According to the present aspect, the liquid coated to the outer peripheral surface of the drum is mainly scraped down by the blade, and is removed from the drum. Moreover, after separating the blade from the drum, the liquid remaining on the peripheral surface of the drum will be blown down by an air and the remaining liquid may be removed from the surface. As a result, the liquid remaining on the peripheral surface of the drum may be removed more reliably.

In a second aspect of the coating device, according to the coating device according to the first aspect, the blowing part may blow the air from a downstream side of the rotation direction of the drum toward an upstream side thereof, and may blow the air at a blowing angle of 30 to 70°.

According to the present aspect, the air is blown from the downstream side of the rotation direction of the drum toward the upstream side thereof, and the air is blown at the blowing angle of 30 to 70°. As a result, the liquid remaining on the outer peripheral surface of the drum may blow down effectively.

In a third aspect of the coating device, according to the coating device of the first or second aspect, the coating device may further include an air heating part that heats the air to be blown from the blowing part, and the air blowing part may blow the air heated by the air heating part.

According to the present aspect, the heated air is blown onto the drum, and the liquid remaining on the drum may blow down. By using the heated air, a fine droplet incapable of being blown down by wind force may dry, thereby enabling to remove the liquid from the drum more reliably.

In a fourth aspect of the coating device, according to the coating device of any one of the first to third aspects, the coating device may further include a cleaning liquid giving part placed in a front end of the blade in the rotation direction of the drum and applies the drum a cleaning liquid.

According to the present aspect, the cleaning liquid is applied to the outer periphery of the drum before removing the liquid by the blade. As a result, the blade may become wet, whereby the process liquid can be removed by the blade effectively. Furthermore, the life of the blade can be extended.

In a fifth aspect of the coating device, according to the coating device of any one of the first to fourth aspects, the coating device may further include a mist collection part for collecting the mist near a position where the air is blown and hit on the drum.

According to the present aspect, the mist collection part is provided near the position where the air is blown and comes into contact therewith. As a result, the mist generated by the blowing can be collected, and a dispersion of pollution to the environment may be prevented.

In a sixth aspect of the coating device, according to the coating device of any one of the first to fifth aspects, on the outer peripheral surface of the drum, a water repellent process is performed at least in a portion in which the blade is separated.

According to the present aspect, the outer peripheral surface of the drum is subjected to the water repellent process. As a result, removing the liquid from the drum can be made with ease. Note that, the residual of liquid becomes a problem in the portion where the blade is separated, and thus, the water repellent process may need to be performed at least in the portion where the blade is separated.

In a seventh aspect of the coating device, according to the coating device of any one of the first to sixth aspects, the control part may always execute a drum cleaning process during execution of the coating process.

According to the present aspect, the drum cleaning process is always executed during execution of the coating process. As a result, even when the medium consecutively transported are sequentially processed, the coating process can be performed without attaching the liquid to rear surfaces of the medium.

In an eighth aspect of the coating device, according to the coating device of any one of the first to seventh aspects, the control part may execute the drum cleaning process before starting the coating process.

According to the present aspect, the drum cleaning process is executed before starting the coating process. As a result, coating process can be started with the outer peripheral surface of the drum in a clean state.

In a ninth aspect of the coating device, according to the coating device of any one of the first to eighth aspects, the control part may execute the drum cleaning process after finishing the coating process.

According to the present aspect, the drum cleaning process is performed after the coating process. Therefore, the apparatus can be stopped while maintaining the outer peripheral surface of the drum in a clean state. As a result, even when the operation is stopped for an extended period of time, the apparatus can safely be maintained. Furthermore, the operation can be started using the drum in the clean state even in the next operation.

In a tenth aspect of the coating device, according to the coating device of any one of the first to sixth aspects, the control part may execute the drum cleaning process before starting the coating process and/or after finishing the coating process, and may execute only the blowing by the blowing part during execution of the coating process.

According to the present aspect, the drum cleaning is performed before starting the coating process and/or after finishing the coating process, and only the blowing is performed during the coating process. When there is a little attachment of the liquid to the drum, the liquid can be removed only by the blowing. Thus, when there is a little attachment of the liquid to the drum, by performing the operation in such a way, life of the blade may be elongated.

According to another aspect of the present invention, there is provided an inkjet recording device which includes the coating device according to any one of the first to tenth aspects; a second transport part for receiving a medium with liquid coated to a surface thereof by the coating device and transports the medium along a predetermined transport path; and an inkjet head for discharging ink droplets onto the surface of the medium to be transported by the second transport part to record an image.

According to the present aspect, even when sequentially processing the medium, the liquid can be coated without attaching the liquid to the rear surface thereof, and thus, an image of a high quality can be recorded.

According to the present invention, the liquid attached to the drum can be removed reliably.

### BRIEF DESCRIPTION OF THE DRAWINGS

FIG. 1 is an overall configuration diagram that shows an embodiment of an inkjet recording device.

FIG. 2 is a conceptual diagram of a roller coating.

FIG. 3 is a block diagram of a schematic configuration of a control system of the inkjet recording device.

FIG. 4 is a schematic configuration diagram of a process liquid coating portion including a drum cleaning unit.

FIG. 5 is a schematic configuration diagram of a blade advance and retreat driving mechanism.

FIGS. 6A and 6B are operation explanatory diagrams of the blade advance and retreat driving mechanism.

FIGS. 7A and 7B are explanatory diagrams of a wiping operation by the blade.

FIG. 8 is a flow chart that shows a sequence of a process when performing the cleaning process of a process liquid coating drum and finishing a printing job.

FIG. 9 is a flow chart that shows a sequence of a process when performing the cleaning process of the process liquid coating drum and starting the printing operation.

FIG. 10 is a schematic configuration diagram of a second embodiment of the process liquid coating portion.

FIG. 11 is a schematic configuration diagram of a third embodiment of the process liquid coating portion.

FIG. 12 is a schematic configuration diagram of a fourth embodiment of the process liquid coating portion.

FIG. 13 is a schematic configuration diagram of a fifth embodiment of the process liquid coating portion.

### DESCRIPTION OF THE PREFERRED EMBODIMENTS

Hereinafter, a preferred embodiment of the present invention will be described in detail according to the attached drawings.

(Overall Configuration)

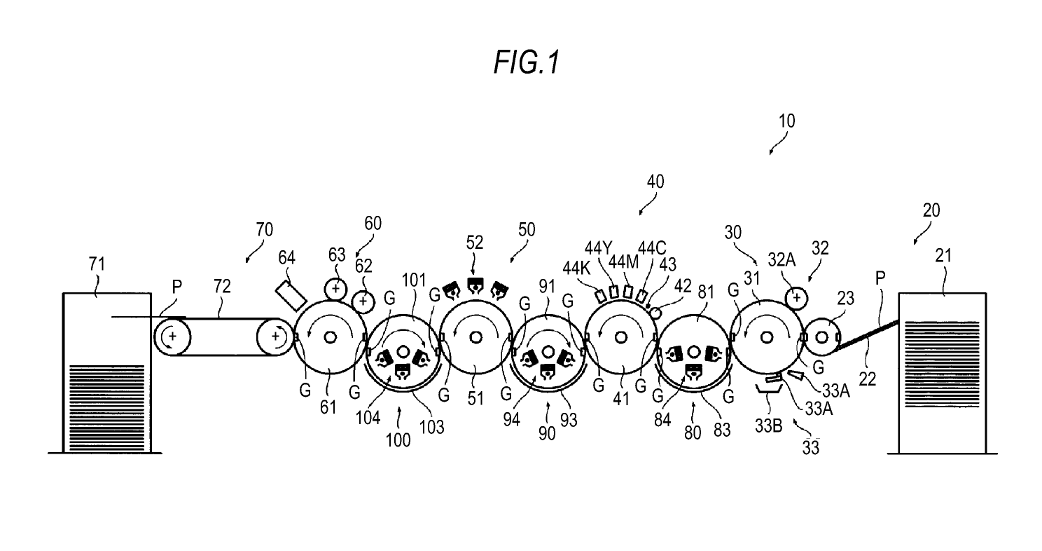

FIG. 1 shows an overall configuration diagram of an embodiment of the inkjet recording device according to the present invention.

An inkjet recording device 10 is a recording device which prints on a sheet of paper (medium) P by an inkjet method using a water based ink (ink containing water in a solvent). The inkjet recording device 10 is mainly constituted by a paper feeding portion 20 that feeds paper P, a process liquid coating portion 30 that coats a predetermined process liquid onto a printing surface (a recording surface) of the paper P, an image recording portion 40 that discharges ink droplets of each color of cyan (C), magenta (M), yellow (Y), and black (K) from an inkjet head onto the printing surface of the paper P, a drying portion 50 that dries the paper P with the image drawn thereon, a fixing portion 60 that fixes the drawn image to the paper P, and a collection portion 70 (collection part) that collects the paper P.

In the respective portions of the process liquid coating portion 30, the image recording portion 40, the drying portion 50, and the fixing portion 60, as a transport part of the paper P, transports drums 31, 41, 51, and 61 are included, respectively. The paper P is transported to the respective portions of the process liquid coating portion 30, the image recording portion 40, the drying portion 50, and the fixing portion 60 by the transport drums 31, 41, 51, and 61.

The respective transport drums 31, 41, 51, and 61 are formed corresponding to a paper width, and driven and rotated by a motor that is a drum rotation part (not shown) (rotated in a counterclockwise direction in FIG. 1).

In the outer peripheral portions of the respective transport drums 31, 41, 51, and 61, grippers G as a gripping part are included. The paper P is transported by being gripped at a tip portion thereof by the gripper G.

Furthermore, the respective transport drums 31, 41, 51, and 61 are equipped with adsorption holding mechanisms (not shown) for sucking and holding the paper P on the outer peripheral surface. The adsorption holding mechanism adsorbs and holds the paper P on the outer peripheral surfaces of the transport drums 31, 41, 51, and 61 using an air pressure (a negative pressure) (a so-called vacuum adsorption). Otherwise, the adsorption holding mechanism adsorbs and holds the paper P on the outer peripheral surfaces of the transport drums 31, 41, 51, and 61 by static electricity (a so-called electrostatic adsorption).

Between the process liquid coating portion 30 and the image recording portion 40, between the image recording portion 40 and the drying portion 50, and between the drying portion 50 and the fixing portion 60, delivery bodies 80, 90, and 100 are placed, respectively. The paper P is transported between the respective portions by the delivery bodies 80, 90, and 100.

The respective delivery bodies 80, 90, and 100 are formed corresponding to the paper width, and are driven and rotated by a motor (not shown) (rotation in a clockwise rotation direction in FIG. 1). The respective delivery bodies 80, 90, and 100 are formed in a frame shape, and include the gripper G in the outer peripheral portion thereof. The paper P is transported by being gripped at the tip portion thereof by the gripper G.

Arch-shaped guide plates 83, 93, and 103 are disposed below the respective delivery bodes 80, 90, and 100 along the transport path of the paper P. The paper P to be transported by the delivery bodies 80, 90, and 100 is transported to the guide plates 83, 93, and 103 while the rear surface (a surface of an opposite side of the printing surface) is guided.

Furthermore, in the inner portions of the respective delivery bodies 80, 90, and 100, driers 84, 94, and 104 which blow hot wind toward the paper P to be transported by the delivery body 80 are placed (in the present example, three delivery bodies are placed along the transport path of the paper P). In addition, the term “drier” corresponds to a blowing part that blows air, and an air heating part that heats the blowing air and converting the same into hot wind. The hot air blown from the driers 84, 94, and 104 in the course of transport is blown and hit on the printing surfaces of the paper P to be transported by the respective delivery bodies 80, 90, and 100.

The paper P is fed from the paper feeding portion 20 and is transported to the transport drum 31 of the process liquid coating portion 30→the delivery body 80→the transport drum 41 of the image recording portion 40→the delivery body 90→the transport drum 51 of the drying portion 50→the delivery body 100→the transport drum 61 of the fixing portion 60→the collection portion 70. Moreover, the required processes are performed in a series of transport courses, and an image is recorded on the printing surface.

In addition, the paper P is transported to the transport drums 31, 41, 51, and 61 so that the printing surface faces outward, and the paper P is transported to the delivery bodies 80, 90, and 100 so that the printing surface faces inward.

Hereinafter, configurations of each portion of the inkjet recording device 10 of the present embodiment will be described in detail.

(Paper Feeding Portion)

The paper feeding portion 20 includes a paper feeding device 21, a paper feeding tray 22, and a delivery body 23. The paper feeding portion 20 consecutively transports sheets of paper P to the process liquid coating portion 30 one by one.

The paper feeding device 21 sequentially feeds the paper P stacked on a magazine (not shown) to the paper feeding tray 22 from the upper side one by one.

The paper feeding tray 22 delivers the paper P fed from the paper feeding device 21 toward the delivery body 23.

The delivery body 23 receives the paper P delivered from the paper feeding tray 22, transports the same along a predetermined transport path, and transfers the same to the transport drum 31 of the process liquid coating portion 30.

In addition, as the printing paper P, a general-purpose paper (a general-purpose printing paper mainly consisting of cellulose such as a high quality paper, a coat paper, and an art paper) is used which is not an inkjet exclusive paper.

(Process liquid Coating Portion)

The process liquid coating portion 30 coats a predetermined process liquid to the printing surface of the paper P. The process liquid coating portion 30 includes the transport drum (hereinafter, referred to as a “process liquid coating drum”) 31 that transports the paper P, a process liquid coating unit 32 that coats a predetermined coating liquid to the printing surface of the paper P to be transported by the process liquid coating drum 31, and a drum cleaning unit 300 that removes the excess process liquid attached to the process liquid coating drum 31.

The process liquid coating drum 31 receives (grips and receives the tip of the paper P by the gripper G) the paper P from the delivery body 23 of the paper feeding portion 20, is rotated, and transports the paper P.

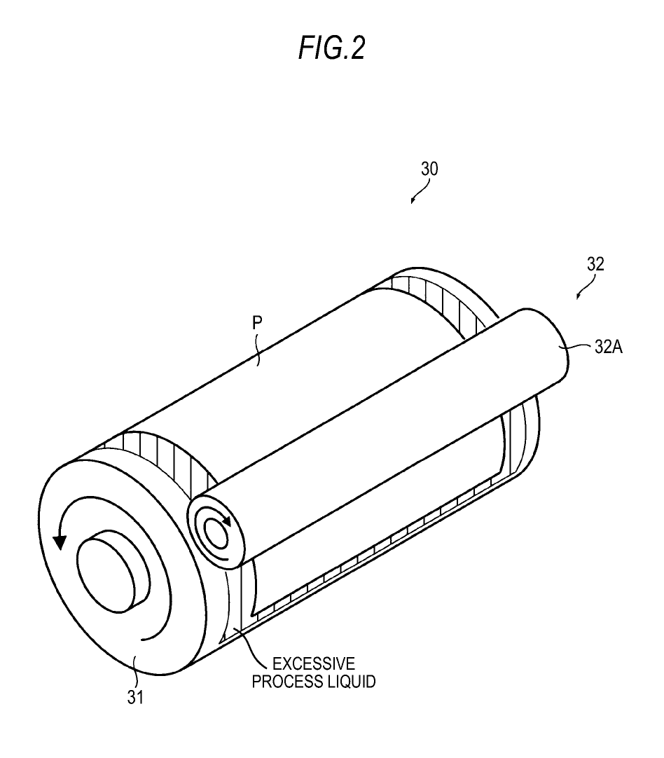

The process liquid coating unit 32 coats the process liquid to the surface of the paper P to be transported by the process liquid coating drum 31. In the present example, as shown in FIG. 2, the paper P is subjected to the roller coating by the coating roller 32A.

The coating roller 32A is formed corresponding to the width of the process liquid coating drum 31 and is provided in parallel with the process liquid coating drum 31. The coating roller 32A is supplied with the process liquid by a process liquid coating mechanism (not shown) (for example, the process liquid pumped from a process liquid tank by an anilox roller is supplied). The process liquid is supplied to the outer peripheral portion of the coating roller 32A with a predetermined thickness.

Furthermore, the coating roller 32A is provided so as to move freely between a predetermined coating position and a retracted position by an advance and retreat movement mechanisms (not shown). The coating roller 32A comes into pressure-contact with the outer peripheral surface of the process liquid coating drum 31 by being moved to the coating position. Furthermore, the coating roller A is separated from the outer peripheral surface of the process liquid coating drum 31 by being moved to the retracted position. Thus, by moving the coating roller 32A to the coating position, it is possible to coat the process liquid to the paper P to be transported by the process liquid coating drum 31.

The process liquid is supplied corresponding to the printing region of the paper P and is supplied to at least a region equal to or greater than the printing region. Thus, in the case of the borderless printing, the process liquid is supplied with a width equal to or greater than the paper width. The coating width of the process liquid is performed by adjusting the supplying width of the process liquid to be supplied to the coating roller 32A.

Herein, as the process liquid to be coated to the process liquid coating portion 30, liquid having a function of agglutinating a color material in ink is used. By coating the process liquid to the paper to perform the printing, the printing to the general-purpose paper becomes possible.

The drum cleaning unit 300 cleans the outer peripheral surface of the process liquid coating drum 31 in a region other than the transport region of the paper P. As described above, in the case of the borderless printing, the process liquid is coated by the coating width equal to or greater than the paper width. For this reason, the process liquid is also attached to the process liquid coating drum side (see FIG. 2). Thus, the process liquid attached to the process liquid coating drum 31 is removed by the drum cleaning unit 300.

In the inkjet recording device 10 of the present embodiment, the process liquid is removed by the blade 310. That is, the blade 310 is brought into contact with the outer peripheral surface of the process liquid coating drum 31, whereby the process liquid attached to the process liquid coating drum 31 is removed by being scraped down.

However, in the process liquid coating drum 31 as mentioned above, the gripper G is included on the outer peripheral surface thereof. Thus, there is a need to separate the bale 310 in the installation portion of the gripper G.

However, when separating the blade 310, in some cases, the process liquid remains in the separated portion.

Thus, the inkjet recording device 10 of the present embodiment has a configuration in which an air nozzle 316 is placed in a rear end of the blade 310, and the process liquid (a so-called liquid stagnation) remaining in the process liquid coating drum 31 when separating the blade 310 is blown down by air. This point will be described later.

According to the process liquid coating portion 30 configured in this manner, the paper P is transported along a predetermined transport path by the process liquid coating drum 31. Moreover, the process liquid is supplied from the process liquid coating unit 32 to the printing surface in the course of transportation. The paper P with the process liquid supplied thereto is then passed from the process liquid coating drum 31 to the delivery body 80 in a predetermined position. Moreover, the paper P is transported along a predetermined path by the delivery body 80, and is passed to the transport drum 41 of the image recording portion 40.

Herein, as mentioned above, a drier 84 is installed in the inner portion of the delivery body 80. The hot wind from the drier 84 is blown and comes into contact therewith in the process of being transported by the delivery body 80, whereby the paper P is subjected to a drying process. As a result, the solvent component in the process liquid is evaporated and removed, whereby an ink aggregation layer is formed on the printing surface.

(Image Recording Portion)

The image recording portion 40 draws a color image on the printing surface of the paper P by shooting ink droplets of each color of C, M, Y, and K to the printing surface of the paper P. The image recording portion 40 includes a transport drum (hereinafter, referred to as an “image recording drum”) 41 that transports the paper P, a paper pressing roller 42 that presses the printing surface of the paper P to be transported by the image recording drum 41 and brings the rear surface of the paper P into close contact with the peripheral surface of the image recording drum 41, a paper floating detection sensor 43 that detects the floating of the paper P passed through the paper pressing roller 42, and inkjet heads 44C, 44M, 44Y, and 44K that ejects the ink droplets of each color of C, M, Y, and K.

The image recording drum 41 receives the paper P from the delivery body 80, is rotated and transports the paper P.

The paper pressing roller 42 is installed near a paper reception position (a position receiving the paper P from the delivery body 80) of the image recording drum 41, is coated with a pressing force by a pressing mechanism (no shown), and is brought into pressure-contact with the peripheral surface of the image recording drum 41. The paper P passed from the delivery body 80 to the image recording drum 41 is nipped by passing though the paper pressing roller 42, and the rear surface thereof comes into close contact with the outer peripheral surface of the image recording drum 41.

The paper floating detection sensor 43 detects the floating paper P (floating from the outer peripheral surface of the image recording drum 41 by a certain amount or more) of the paper P passing through the paper pressing roller 42. The paper floating detection sensor 43 includes, for example, a laser emitter and a laser receiver. The laser emitter emits a laser beam parallel to an axis of the image recording drum 41 to a position of a predetermined height from the outer peripheral surface of the image recording drum 41 from one end of the image recording drum 41 toward the other end thereof. The laser receiver is placed so as to face the laser emitter with the image recording drum 41 interposed therebetween, and receives the laser beam emitted from the laser emitter. When the floating is generated in the paper P passed through the paper pressing roller 42 for a predetermined amount or more, the laser beam emitted from the laser emitter is blocked by the paper P and is not received by the laser receiver. The paper floating detection sensor 43 detects the presence or the absence of the laser beam by the laser receiver, and detects the floating of the paper P.

Four inkjet heads 44C, 44M, 44Y, and 44K are placed in the rear end of the paper floating detection sensor 43 and are placed along the transport path of the paper P at regular intervals. The inkjet heads 44C, 44M, 44Y, and 44K are constituted by line heads corresponding to the paper width, and discharge the ink droplets of the corresponding color from the nozzle rows formed on the nozzle surface toward the image recording drum 41.

According to the image recording portion 40 configured in this manner, the paper P is transported along a predetermined transport path by the image recording drum 41. The paper P passed from the delivery body 80 to the image recording drum 41 is firstly nipped by the paper pressing roller 42, and comes into close contact with the outer peripheral surface of the image recording drum 41. Next, the presence or the absence of the paper floating is detected by the paper floating detection sensor 43, and then, the ink droplets of each color of C, M, Y, and K are shot from the respective inkjet heads 44C, 44M, 44Y, and 44K, and the color image is drawn on the printing surface.

Herein, in the inkjet recording device 10 of the present example, water based ink with thermoplastic resin dispersed in ink for each color is used. Even in the case of using such a water based ink, as mentioned above, a predetermined process liquid is supplied to the paper P, and thus, printing of high quality without generating the feathering, the bleeding or the like is possible.

The paper P with the image drawn thereon is passed to the delivery body 90, is transported along a predetermined transport path by the delivery body 90, and is passed to the transport drum 51 of the drying portion 50.

Herein, as described above, a drier 84 is installed in the inner portion of the delivery body 90. The paper P is subjected to a preliminary drying even in the course of being transported by the delivery body 90.

(Drying Portion)

The drying portion 50 dries a liquid component remaining in the paper P after the image recording. The dying portion 50 includes a transport drum (hereinafter, also referred to as an “ink drying drum”) 51 that transports the paper P, and an ink drying device 52 that performs a drying process on the paper P transported by the ink drying drum 51.

The ink drying drum 51 receives the paper P from the delivery body 90, is rotated, and transports the paper P.

The ink drying device 52 is constituted by, for example, driers (in the present example, three driers disposed along the transport path of the paper P), and dries ink (evaporates the liquid component existing on the paper) by blowing of a hot wind (for example, 80° C.) toward the paper P to be transported by the ink drying drum 51.

According to the drying portion 50 configured in this manner, the paper P is transported by the ink drying drum 51. Moreover, the hot wind is blown from the ink drying device 52 to the printing surface in the process of transportation, and ink supplied to the printing surface is dried.

The paper P passed through the ink drying device 52 is then passed from the ink drying drum 51 to the delivery body 100 in a predetermined position. Moreover, the paper is transported along a predetermined transport path by the delivery body 100, and is passed to the transport drum 61 of the fixing portion 60.

Herein, as described above, the drier 104 is installed in the inner portion of the delivery body 100. The paper P is subjected to the preliminary drying even in the course of being transported by the delivery body 100.

(Fixing Portion)

The fixing portion 60 heats and presses the paper P, and fixes the image recorded on the printing surface. The fixing portion 60 includes a transport drum (hereinafter, referred to as a “fixing drum”) 61 that transports the paper P, heat rollers 62 and 63 that perform the heating and pressing process on the paper P to be transported by the fixing drum 61, and an in-line sensor 64 that detects a temperature, a humidity or the like of the paper P after the printing and images the printed image.

The fixing drum 61 receives the paper P from the delivery body 100, is rotated, and transports the paper P.

The heat rollers 62 and 63 weld the thermoplastic resin dispersed in ink by heating and pressing ink supplied to the printing surface of the paper P and reduce the thickness of ink. Furthermore, along with this, a deformation such as cockling and curling generated in the paper P is corrected. The respective heat rollers 62 and 63 are formed in approximately the same width as that of the fixing drum 61, and are heated to a predetermined temperature by a built-in heater. Furthermore, the respective heater rollers 62 and 63 come into pressure-contact with the peripheral surface of the fixing drum 61 by a predetermined pressing force through a pressing part (not shown). The paper P is heated and pressed by the heat rollers 62 and 63 by passing through the heat rollers 62 and 63.

The in-line sensor 64 includes a thermometer, a hygrometer, a CCD line sensor or the like, detects the temperature, the humidity or the like of the paper P to be transported by the fixing drum 61, and images the image printed on the paper P. Abnormality of the apparatus, discharging defects of the head or the like are checked based on the detection result of the in-line sensor 64.

According to the fixing portion 60 configured in this manner, the paper P is transported by the fixing drum 61, and the heat rollers 62 and 63 come into pressure-contact with the printing surface in the course of transportation, and are heated and pressed. As a result, the thermoplastic resin dispersed in ink is welded, and the thickness of the ink becomes thin. Furthermore, along with this, the deformation generated in the paper P is corrected.

The paper P subjected to the fixing process is then passed from the fixing drum 61 to the collection portion 70 in a predetermined position.

(Collection Portion)

The collection portion 70 stacks paper P subjected to a series of printing processes on the stacker 71, and collects the same. The collection portion 70 includes the stacker 71 that collects the paper P, and a paper discharging conveyor 72 that receives the paper P subjected to the fixing process by the fixing portion 60 from the fixing drum 61, transports the paper P along a predetermined transport path, and discharges the paper P to the stacker 71.

The paper P subjected to the fixing process by the fixing portion 60 is passed from the fixing drum 61 to the paper discharging conveyor 72, is transported up to the stacker 71 by the paper discharging conveyor 72, and is collected into the stacker 71.

(Control System)

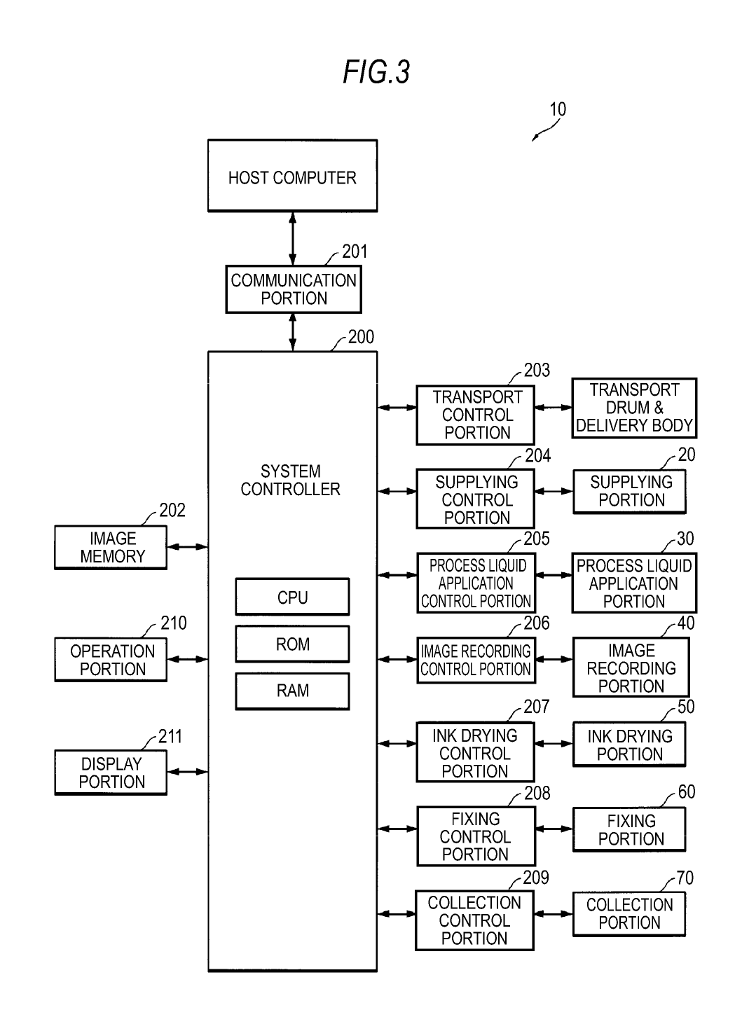

FIG. 3 is a block diagram that shows a schematic configuration of a control system of the inkjet recording device 10 of the present embodiment.

As shown in FIG. 3, the inkjet recording device 10 includes a system controller 200 as a control part, a communication portion 201, an image memory 202, a transport control portion 203, a paper feeding control portion 204, a process liquid coating control portion 205, an image recording control portion 206, an ink drying control portion 207, a fixing control portion 208, a collection control portion 209, an operation portion 210, a display portion 211 or the like.

The system controller 200 functions as a control part that generally controls the respective portions of the inkjet recording device 10 and functions as a calculation part that performs various calculation processes. The system controller 200 includes a CPU, a ROM, a RAM or the like, and is operated according to a predetermined control program. A control program to be executed by the system controller 200 and various data required for the control are stored in the ROM.

The communication portion 201 includes a required communication interface, and performs the transmission and reception of data between the communication portion 201 and a host computer connected to the communication interface.

The image memory 202 functions as a temporary storage part of various data including the image data, and performs the reading and writing of data through the system controller 200. The image data received from the host computer via the communication portion 201 is stored in the image memory 202.

The transport control portion 203 controls the driving of the transport drums 31, 41, 51, and 61 which are transport part of the paper Pin each portion of the process liquid coating portion 30, the image recording portion 40, the drying portion 50, and the fixing portion 60, and the delivery bodies 80, 90, and 100.

That is, the transport control portion 203 controls the driving of the motor that drives the respective transport drums 31, 41, 51, and 61, and controls the opening and the closing of the grippers G provided in the respective transport drums 31, 41, 51, and 61.

In this manner, the transport control portion 203 controls the driving of the motor that drives the respective delivery bodies 80, 90, and 100, and controls the opening and the closing of the grippers G provided in the respective delivery bodies 80, 90, and 100.

Furthermore, since the respective transport drums 31, 41, 51, and 61 are provided with mechanisms that adsorb and hold the paper P to the peripheral surface, the driving of the adsorption and holding mechanism is controlled (in the present example, since the paper P is vacuum-adsorbed, the driving of the vacuum pump as the negative generating part is controlled).

Furthermore, since the respective delivery bodies 80, 90, and 100 are provided with the driers 84, 94, and 104, the driving thereof (a heating amount and a blowing amount) is controlled.

The driving of the transport drum 31, 41, 51 and 61 and the driving of the delivery bodies 80, 90, and 100 are controlled depending on the command from the system controller 200.

The paper feeding control portion 204 controls the driving of each portion (the paper feeding device 21, the delivery body 23 or the like) constituting the paper feeding portion 20 depending on the command from the system controller 200.

The process liquid coating control portion 205 controls each portion (the process liquid coating unit 32, the drum cleaning unit 300 or the like) constituting the process liquid coating portion 30 depending on the command from the system controller 200.

The image recording control portion 206 controls the driving of each portion (the paper pressing roller 42, the inkjet heads 44C, 44M, 44Y, and 44K, the like) constituting the image recording portion 40 depending on the command from the system controller 200.

The ink drying control portion 207 controls each portion (the ink drying device 52 or the like) constituting the drying portion 50 depending on the command from the system controller 200.

The fixing control portion 208 controls the driving of each portion (the heat rollers 62 and 63, the in-line sensor 64 or the like) constituting the fixing portion 60 depending on the command from the system controller 200.

The collection control portion 209 controls the driving of each portion (the paper discharging conveyor 72 or the like) constituting the collection portion 70 depending on the command from the system controller 200.

The operation portion 210 includes a required operation part (for example, an operation button, a key board, a touch panel or the like), and outputs the operation information, which is input from the operation part, to the system controller 200. The system controller 200 executes various processes depending on the operation information which is input from the operation portion 210.

The display portion 211 includes a required display device (for example, an LCD panel or the like), and displays required information on the display device depending on the command from the system controller 200.

As described above, the image data to be recorded on the paper is received from the host computer to the inkjet recording device 10 via the communication portion 201 and is stored in the image memory 202. The system controller 200 adds a required signal process to the image data stored in the image memory 202 to generate the dot data, and controls the driving of each inkjet head of the image recording portion 40 depending on the generated dot data, thereby recording the image indicated by the image data on the paper.

The dot data is generated generally by performing a color conversion process, and a halftone process on the image data. The color conversion process is a process of converting the image data (for example, image data of RGB 8 bit) represented by sRGB or the like into ink amount data of each color of ink used in the inkjet recording device 10 (in the present example, the image data is converted into ink amount data of each color of C, M, Y, K). The halftone process is a process of converting ink amount data of each color generated by the color conversion process into each color dot data by a process such as error diffusion.

The system controller 200 performs the color conversion process and the halftone process on the image data to generate the dot data of each color. Moreover, by controlling the driving of the corresponding inkjet head according to the dot data of each color generated, the image indicating the image data is recorded on the paper.

(Printing Operation)

Next, a printing operation of the inkjet recording device 10 will be described.

When the paper feeding command is output from the system controller 200 to the paper feeding device 21, the paper P is fed from the paper feeding device 21 to the paper feeding tray 22. The paper P fed to the paper feeding tray 22 is passed to the process liquid coating drum 31 of the process liquid coating portion 30 via the delivery body 23.

The paper P passed to the process liquid coating drum 31 is transported along a predetermined transport path by the process liquid coating drum 31, and the process liquid is supplied to the printing surface through the process liquid coating unit 32 in the course of transportation.

The paper P with the process liquid is passed from the process liquid coating drum 31 to the delivery body 80, is transported along a predetermined transport path by the delivery body 80, and is passed to the image recording drum 41 of the image recording portion 40. Moreover, the hot wind is blown from the drier 84 installed inside the delivery body 80 to the printing surface in the course of transportation by the delivery body 80, whereby the process liquid supplied to the printing surface is dried.

The paper P passed from the delivery body 80 to the image recording drum 41 is nipped in the paper pressing roller 42 firstly by passing through the paper pressing roller 42, and comes into close-contact with the outer peripheral surface of the image recording drum 41. After that, ink droplets of each color of CMYK is shot from the respective inkjet heads 44C, 44M, 44Y, and 44K through the respective inkjet heads 44C, 44M, 44Y, and 44K, and the color image is drawn on the printing surface. The paper P with the drawn image is then passed from the image recording drum 41 to the delivery body 90.

The paper P passed to the delivery body 90 is transported along a predetermined transport path by the delivery body 90, and is passed to the ink drying drum 51 of the drying portion 50. Moreover, the hot wind is blown from the drier 94 installed inside the delivery body 90 to the printing surface in the process of transportation, and ink supplied to the printing surface is dried.

The paper P passed to the ink drying drum 51 is transported along a predetermined transport path by the ink drying drum 51, the hot wind is blown from the ink drying device 52 to the printing surface in the process of transportation, and the liquid component remaining on the printing surface is dried.

The dried paper P is passed from the ink drying drum 51 to the delivery body 100, is transported along a predetermined transport path, and is passed to the fixing drum 61 of the fixing portion 60. Moreover, in the course of transportation by the delivery body 100, the hot wind is blown from the direr 104 installed inside the delivery body 100 to the printing surface, whereby ink supplied to the printing surface is further dried.

The paper P passed to the fixing drum 61 is transported along a predetermined transport path by the fixing drum 61, is heated and pressed to the heat rollers 62 and 63 in the course of transportation, and the image recorded on the printing surface is fixed. After that, the paper P is passed from the fixing drum 61 to the paper discharging conveyor 72 of the collection portion 70, is transported up to the stacker 71 by the paper discharging conveyor 72, and is discharged into the stacker 71.

As mentioned above, in the inkjet recording device 10 of the present embodiment, the paper P is transported by the drum, the respective processes of the giving of the process liquid, the drying of the process liquid, the shooting of the ink droplet, the drying, and the fixing are performed on the paper P in the course of transportation, and a predetermined image is recorded on the paper P.

(Process Liquid Coating Portion)

As mentioned above, when performing the borderless printing, the process liquid is also attached to the process liquid coating drum 31. The process liquid is gradually accumulated while continuing to print, and flows to the peripheral surface by centrifugal force due to the rotation. There is a problem that the process liquid flowed to the peripheral surface of the process liquid coating drum 31 is attached to the rear surface of the paper P to be transported later, degrades the print quality, or pours into the gripper G, thereby causing the transportation defect. Furthermore, since the process liquid is generally strong acid, there is also a problem that the same corrodes the peripheral members when being left for a long time. Thus, there is a need to early remove the process liquid.

Thus, the process liquid coating portion 30 of the inkjet recording device 10 of the present embodiment is provided with the drum cleaning unit 300 for cleaning the process liquid coating drum 31.

### First Embodiment

Hereinafter, a configuration of the process liquid coating portion 30 (the coating device) including the drum cleaning unit 300 will be described.

(Configuration)

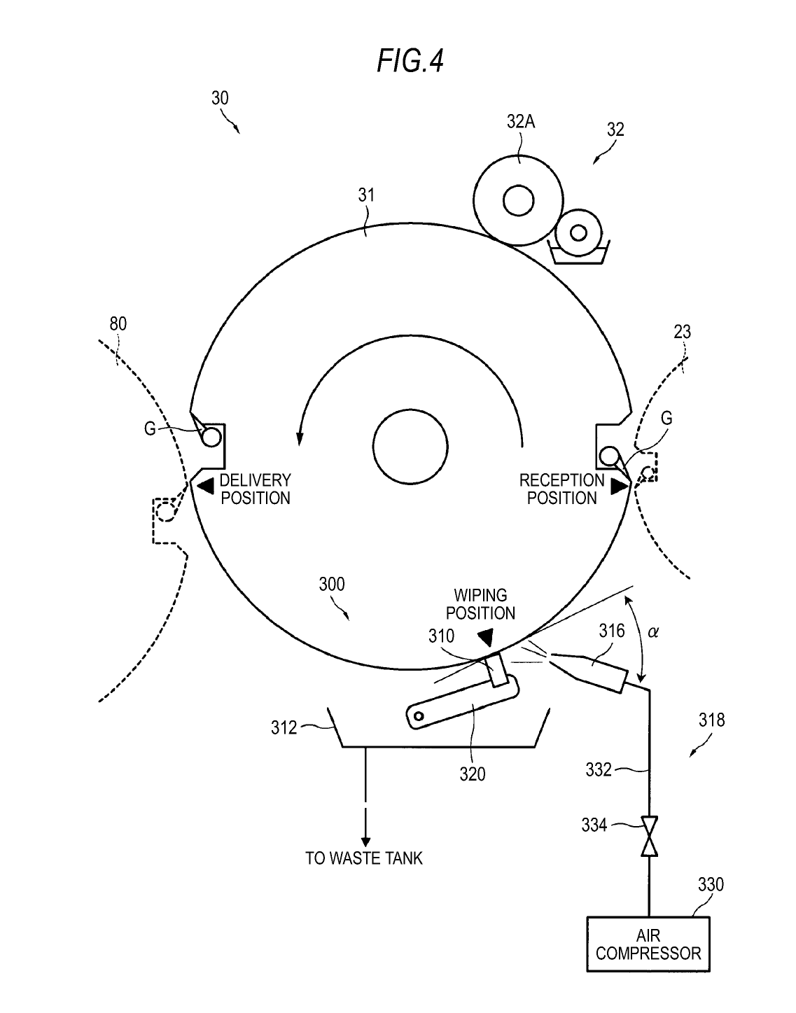

FIG. 4 is a schematic configuration diagram of the process liquid coating portion 30 including the drum cleaning unit 300.

As mentioned above, the process liquid coating portion 30 includes the process liquid coating drum 31, the process liquid coating unit 32, and the drum cleaning unit 300.

The process liquid coating drum 31 transports the paper P along a predetermined transport path by being rotated while gripping the tip of the paper P by the gripper G. The gripper G receives the paper P from the delivery body 23 in a predetermined reception position and passes the paper P to delivery body 80 in a predetermined delivery position. The paper P is transported while being wound around the peripheral surface of the process liquid coating drum 31 between the reception position and the delivery position. Thus, the outer peripheral surface of the process liquid coating drum 31 formed by the reception position and the delivery position becomes the transport path of the paper P.

The process liquid coating unit 32 is installed on the transport path of the paper P. As mentioned above, the process liquid coating unit 32 presses the coating roller 32A against the surface of the paper P transported by the process liquid coating drum 31, and coats the process liquid to the surface of the paper P.

The coating roller 32A is supplied with the process liquid on the outer peripheral surface thereof with a predetermined width and thickness. The process liquid supplied to the outer peripheral surface of the coating roller 32A is transferred to the paper P, and the process liquid is coated to the paper P. The width and the thickness of the process liquid supplied to the coating roller 32A are configured so as to be arbitrarily adjustable. The coating width and the coating thickness of the process liquid to be coated to the paper P are adjusted by adjusting the width and the thickness of the process liquid to be supplied to the coating roller 32A.

Furthermore, the coating roller 32A is provided so as to be freely moved back and forth to the outer peripheral surface of the process liquid coating drum 31. Moreover, the coating roller 32A is driven by an advance and retreat driving mechanism (not shown), and comes into contact with and is separated from the outer peripheral surface of the process liquid coating drum 31. The contact/separation to and from the process liquid coating drum 31 are performed in conjunction with the rotation of the process liquid coating drum 31. That is, when the gripper G passes, the coating roller 32A is separated.

The drum cleaning unit 300 is installed in a region other than the transport path of the paper P, that is, a region where the paper P does not pass, and removes the process liquid attached to the outer peripheral surface of the process liquid coating drum 31. As mentioned above, since the process liquid coating drum 31 is rotated around a counter-clockwise direction in FIG. 4, and transports the paper P between the reception position and the delivery position, the process liquid coating drum 31 is installed in a region between the delivery position and the reception position, that is, in a lower region of the process liquid coating drum 31.

The drum cleaning unit 300 mainly includes the blade 310, a collection dish 312 that collects the process liquid removed by the blade 310, a blade advance and retreat driving mechanism 314 (blade advance and retreat driving part) for bringing the blade 310 into contact with and separating the blade 310 from the outer periphery of the process liquid coating drum 31, an air nozzle 316 that ejects air toward the contact portion of the blade 310, and an air supplying device 318 that supplies the air nozzle 316 with air.

The blade 310 is formed corresponding to the width of the process liquid coating drum 31. That is, the blade 310 is formed to have a length capable of wiping the overall width of the process liquid coating drum 31. The blade 31 comes into contact with the outer peripheral surface of the process liquid coating drum 31, whereby the process liquid attached to the outer peripheral surface is scraped off by the blade 310.

The blade 310 comes into contact with the outer peripheral surface of the process liquid coating drum 31 in a predetermined wiping position. The wiping position of the blade 310 is set in the lower region of the process liquid coating drum 31 so as to easily scrape off the process liquid.

The collection dish 312 is formed in a dish shape with an open upper portion, surrounds the blade 310, and is installed in the lower position of the blade 310. The process liquid scraped off by the blade 310 falls by its own weight, and is collected in the collection dish 312.

The collection dish 312 is connected to a waste tank (not shown) via a waste pipe (not shown). The process liquid collected by the collection dish 312 is collected to the waste tank.

The blade advance and retreat driving mechanism 314 separates the blade 310 from the process liquid coating drum 31 according to the passage of the gripper G

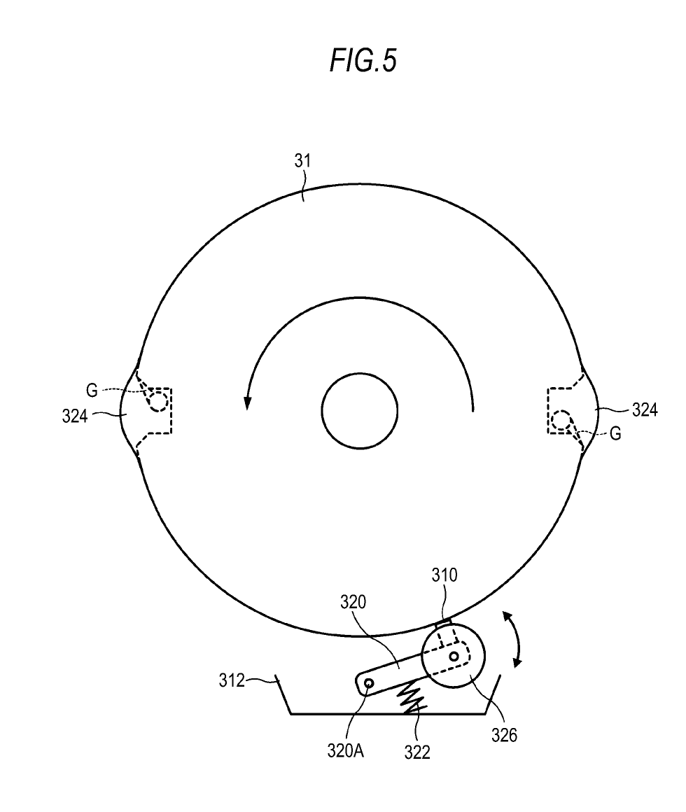

FIG. 5 is a schematic configuration diagram of the blade advance and retreat driving mechanism 314.

The blade advance and retreat driving mechanism 314 mainly includes a swing arm 320 that supports the blade 310 in a freely oscillating manner, a spring 322 that biases the swing arm 320, cams 324 that are provided in both edge portions of the outer periphery of the process liquid coating drum 31, a cam follower 326 that is provided in the swing arm 320.

The swing arms 320 are formed in an elongated shape, respectively, and a proximal end portion thereof is provided with an oscillation shaft 320A. The oscillation shaft 320A is pivotally supported on the collection dish 312 via a bracket (not shown). The swing arm 320 is supported around the oscillation shaft 320A in a freely oscillating manner.

A tip of the swing arm 320 is provided with a blade attachment portion (not shown). The blade 310 is fixed to the blade attachment portion provided in the tip portion of the swing arm 320 at both end portions thereof, and is attached to the swing arm 320.

The blade 310 attached to the swing arm 320 comes into contact with and is separated from the process liquid coating drum 31 by the oscillation of the swing arm 320.

The spring 322 biases each swing arm 320 so that the blade 310 comes into contact with the outer peripheral surface of the process liquid coating drum 31. One end of the spring 322 is fixed to the swing arm 320, and the other end thereof is fixed to the collection dish via a bracket (not shown).

The cams 324 are formed as arc-shaped protrusions in both edges (regions where the paper P is not held) of the outer peripheral portion of the process liquid coating drum 31. The cams 324 are formed in the installation position of the gripper G, and are formed to have a height equal to or greater than a protrusion amount of the gripper G.

The cam follower 326 is formed in a roller shape and is attached to the tip of the swing arm 320 in a freely rotating manner. The cam follower 326 is placed corresponding to the installation position of the cam 324.

The blade advance and retreat driving mechanism 314 is configured as below.

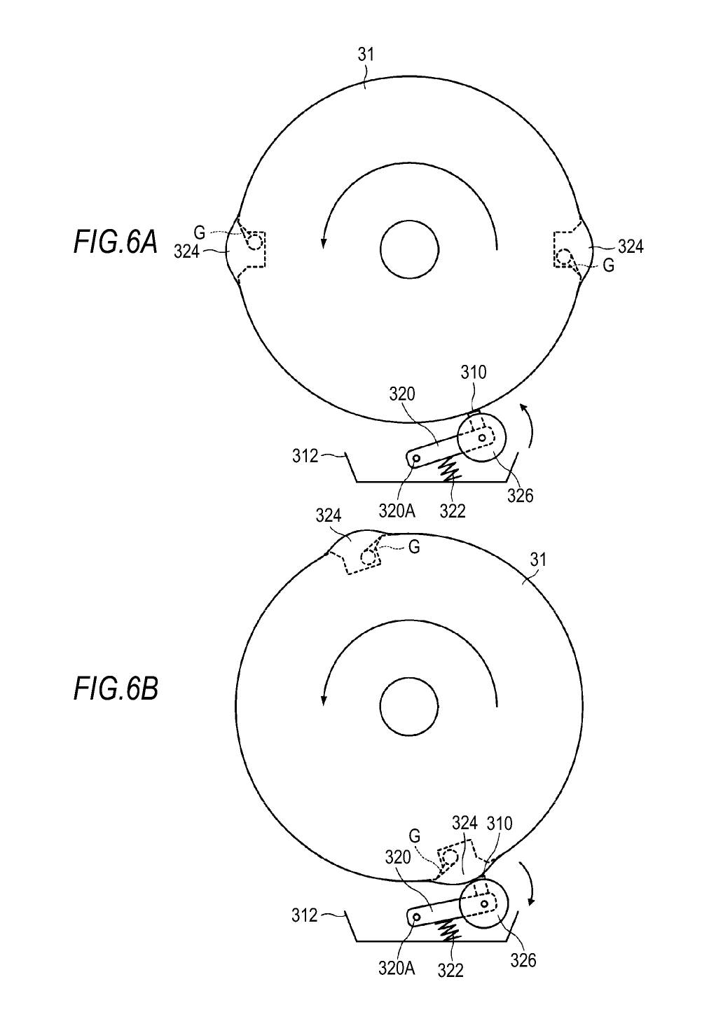

As shown in FIG. 6A, in a region other than the installation portion of the gripper G, the blade 310 is biased to the spring 322, and comes into pressure-contact with the outer peripheral surface of the process liquid coating drum 31.

When the process liquid coating drum 31 is rotated and blade 310 reaches the installation portion of the gripper G, as shown in FIG. 6B, the cam follower 326 rides the cam 324. As a result, the blade 310 is forcibly separated from the outer peripheral surface of the process liquid coating drum 31.

When passing though the installation portion of the gripper G, the blade 310 is biased to the spring 322 again, and comes into pressure-contact with the outer peripheral surface of the process liquid coating drum 31.

As mentioned above, the blade advance and retreat driving mechanism 314 brings the blade 310 into contact with and separates the blade 310 from the process liquid coating drum 31 in conjunction with the rotation of the process liquid coating drum 31, thereby avoiding that the blade 310 comes into contact with the gripper G.

The air nozzle 316 is formed corresponding to the width of the process liquid coating drum 31 like the blade 310. That is, the nozzle 316 is able to blow air to the whole width of the process liquid coating drum 31. For this reason, a slit-shaped outlet corresponding to the width of the process liquid coating drum 31 is formed.

The air nozzle 316 is installed so as to eject air toward the wiping position of the blade 310. That is, the air nozzle 316 is installed so as to blow down the process liquid remaining on the outer peripheral surface of the process liquid coating drum 31 to the collection dish 312 when separating the blade 310.

In this case, a blowing angle α (angle formed by a tangent and an ejection direction in the wiping position) is obtained by a test, a simulation or the like, but it is preferable that the blowing angle be set within the range of 30 to 70° (more, preferable 40 to 50°). As a result, it is possible to effectively blow down the process liquid.

The air supplying device 318 includes an air compressor 330, an air supplying pipe 332 that guides the compressed air generated by the air compressor 330 to the air nozzle 316, and an air valve 334 that is placed in the middle of the air supplying pipe 332.

The system controller 200 controls the driving of the air supplying device 318 via the process liquid coating control portion 205, and controls the supplying of air from the air nozzle 316.

At this time, a airflow speed of air ejected from the air nozzle 316 is set to a value sufficient to blow down the process liquid remaining in the process liquid coating drum 31, and is obtained by a test, a simulation or the like. However, the airflow speed is preferably set within the range of 10 to 30 m/s (more preferably, 10 to 15 m/s).

(Action)

The process liquid coating portion 30 including the drum cleaning unit 300 is configured as mentioned above.

Next, the coating operation and the cleaning operation of the process liquid will be described.

Firstly, the coating operation will be described.

The paper P is fed from the delivery body 23. The paper P fed from the delivery body 23 is gripped by the gripper G at the tip portion thereof, and is passed to the process liquid coating drum 31. The process liquid coating drum 31 receiving the paper P is rotated to transport the paper P.

The paper P passes through the process liquid coating unit 32 in the course of transportation, and the process liquid is coated to the upper surface thereof. That is, when passing though the process liquid coating unit 32, the coating roller 32A is pressed to the upper surface, and the process liquid is coated to the upper surface with a predetermined coating width and coating thickness.

The paper P coated with the process liquid is transported up to the delivery position, and is passed to the delivery body 80.

In this manner, the coating roller 32A is pressed to the paper P transported by the process liquid coating drum 31, and the process liquid is coated to the paper P with a predetermined coating width and coating thickness.

Next, the cleaning operation of the process liquid coating drum 31 will be described.

The cleaning of the process liquid coating drum 31 is always operated during coating operation, which is during printing process by the inkjet recording device 10.

When the printing process is started, the air supplying device 318 is driven and the air is ejected from the air nozzle 316. The air is ejected toward the wiping position (a position where the blade 310 comes into contact therewith) of the process liquid coating drum 31.

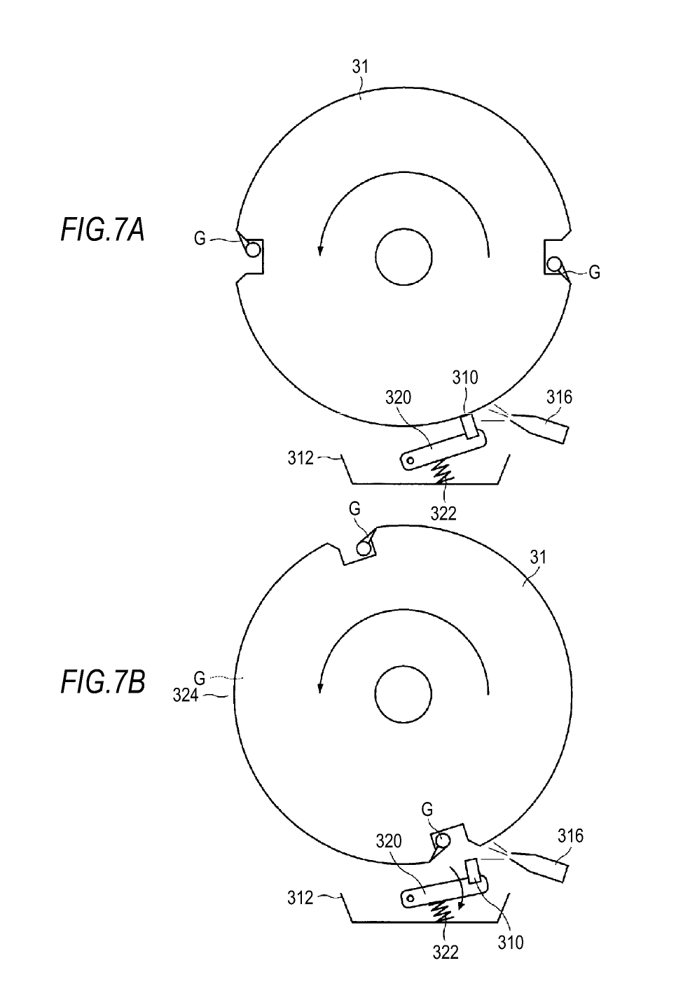

As shown in FIG. 7A, in a region other than the installation portion of the gripper G, the blade 310 is biased to the spring 322, and comes into pressure-contact with the outer peripheral surface of the process liquid coating drum 31.

Thus, even in a case where the process liquid coated by the coating roller 32A is attached to the process liquid coating drum 31, the process liquid is scraped down from the process liquid coating drum 31 by passing through the installation position (the wiping position) of the blade 310. Thus, before transporting the paper P to be processed later (before reaching the reception position), the outer peripheral surface of the process liquid coating drum 31 is trimmed in a clean state.

The process liquid scraped down from the process liquid coating drum 31 by the blade 310 is collected by the collection dish 312 and is discarded to the waste tank.

Meanwhile, since the process liquid coating drum 31 is provided with the gripper G, as shown in FIG. 7B, in the installation portion of the gripper G, there is a need to separate the blade 310 from the outer periphery of the process liquid coating drum 31.

The blade 310 is automatically separated from the process liquid coating drum 31 in the installation portion of the gripper G by the blade advance and retreat driving mechanism 314.

Herein, when separating the blade 310 from the outer peripheral surface of the process liquid coating drum 31, in some cases, the process liquid remains in a point separating the blade 310 (a so-called liquid stagnation is generated).

However, in the process liquid coating portion 30 of the present example, since the air is ejected from the air nozzle 316 toward the wiping position, when separating the blade 310, the process liquid remaining on the outer peripheral surface of the process liquid coating drum 31 is removed by air ejected from the air nozzle 316. That is, the process liquid is blown down by the wind pressure of air ejected from the air nozzle 316. The process liquid blown down is also collected by the collection dish 312.

In this manner, in the process liquid coating portion 30 of the present embodiment, the process liquid coating drum 31 is cleaned in conjunction with the coating of the process liquid. As a result, even in the case of continuously performing the coating process of the paper P (=the case of continuously performing the printing process), the process liquid can be coated without generating the back printing or the like in the paper P.

Furthermore, even in a case where the blade 310 needs to be separated, the process liquid coating drum 31 can be cleaned without causing the wiping residue.

In addition, in the example mentioned above, during coating process (during printing process), the cleaning process of the process liquid coating drum 31 is always executed. However, when there is less dirt on the process liquid coating drum 31 (for example, when the borderless printing is not performed), the cleaning operation is not performed during coating process, but the cleaning operation may be performed after finishing the first printing job. In this case, the coating operation is not performed, but the process liquid coating drum 31 is rotated (idling) to perform only the cleaning operation. Furthermore, in this case, since the cleaning operation is not performed during coating process, the blade 310 is always separated from the process liquid coating drum 31 during coating process. For this reason, there is a need for a lock mechanism that locks the blade 310 in the separated position.

Furthermore, the cleaning operation may be executed before starting the coating process (the printing process), and may be performed at any timing during coating process. In addition, the cleaning operation may automatically be performed whenever the process liquid coating drum 31 is rotated by a prescribed number of times, may automatically be performed for each predetermined time, and may automatically be performed whenever performing the coating process by a prescribed number of sheets.

Furthermore, even in the case of not performing the cleaning operation during coating operation, only the ejection of air may be performed. That is, even in the case of not performing the cleaning operation by the blade 310, only the ejection of air is performed. When the dirt is less or the like, a sufficient cleaning effect can be obtained only by the ejection of air. Meanwhile, even in a case where the dirt is less, when performing the cleaning operation by the blade 310, the blade 310 easily deteriorates. Thus, it is possible to promote an increase in life of the blade 310, only by performing the ejection of air.

In addition, regardless of whether or not the cleaning operation is performed during coating process, it is desirable to always perform the cleaning operation of the process liquid coating drum 31 after the process of the final paper. That is, when the printing job is finished, it is desirable to perform and finish the cleaning operation of the process liquid coating drum 31. As a result, it is possible to always maintain the process liquid coating drum 31 in a clean state even during shutdown.

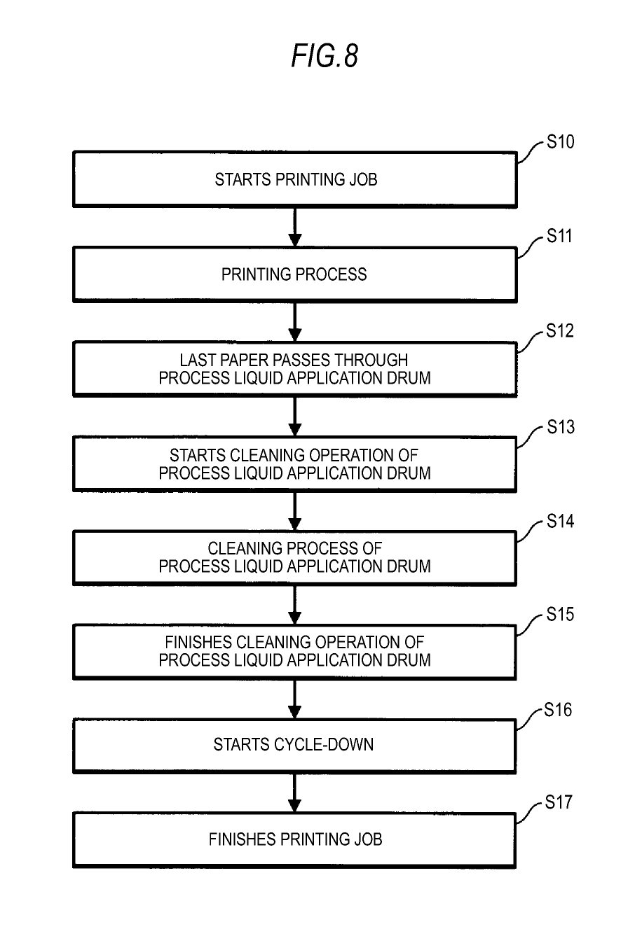

FIG. 8 is a flow chart that shows a sequence of the process when performing the cleaning process of the process liquid coating drum and finishing the printing job.

A command of the starting of the printing job is received, and the printing job is started (step S10). When the printing process is executed (step S11) and the final paper passes through the process liquid coating drum 31 (step S12), the cleaning operation of the process liquid coating drum 31 is started (step S13). The cleaning operation is performed by causing the process liquid coating drum 31 to idle for a predetermined time (step S14). Moreover, when the cleaning operation is finished in the process liquid coating drum 31 (step S15), a cycle-down of the inkjet recording device 10 is started (step S16), and the printing job is finished (step S17).

In this manner, it is possible to always maintain the process liquid coating drum 31 in a clean state by performing the cleaning process of the process liquid coating drum 31 and finishing the printing job after processing the final paper.

Even when the printing job is started, similarly, it is desirable to perform the cleaning process of the process liquid coating drum 31 and start the printing process.

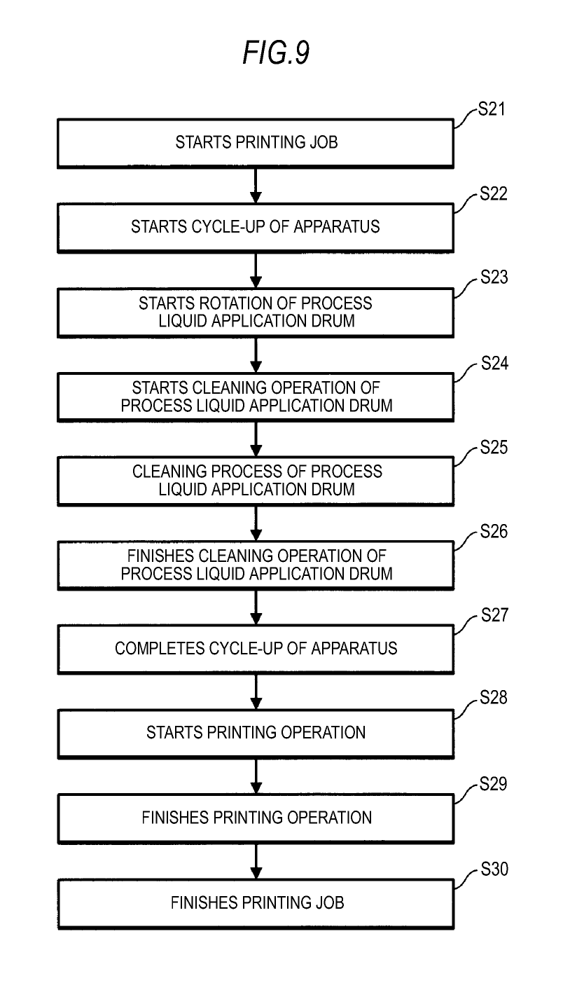

FIG. 9 is a flow chart that shows a sequence of the process when performing the cleaning process of the process liquid coating drum and starting the printing operation.

The command of the starting of the printing job is received, and the printing job is started (step S21).

Firstly, in order to make the respective portions an operable state, a cycle-up of the inkjet recording device is started (step S22). In the process liquid coating portion 30, the rotation of the process liquid coating drum 31 is started (step S23). Moreover, the cleaning operation is started on the rotating process liquid coating drum 31 (step S24), whereby the cleaning process is performed (step S25). The cleaning process is continuously performed for a predetermined time. Moreover, when the cleaning operation is completed in the process liquid coating drum 31 (step S26) and the cycle-up of the inkjet recording device 10 is completed (step S27), the printing operation is started (step S28). After that, the printing process of contents depending on the command is performed (step S29), and the process of the printing job is finished (step S30).

In this manner, by performing the cleaning operation of the process liquid coating drum 31 before starting the printing, for example, it is possible to remove the dirt or the like attached to the process liquid coating drum 31 during shutdown. As a result, it is possible to transport the paper P by the process liquid coating drum 31 in the clean state.

In this manner, by performing the cleaning process of the process liquid coating drum 31 even before the printing and after the printing as well as during printing, it is possible to always maintain the process liquid coating drum 31 in the clean state, and perform the stable transport of the paper P.

In addition, the air nozzle of the present example has a configuration in which the air is blown from the slit-shaped outlet, but the ejection shape of air is not particularly limited thereto. The ejection shape may have a configuration that is able to eject air over the width direction of the process liquid coating drum 31.

### Second Embodiment

(Configuration)

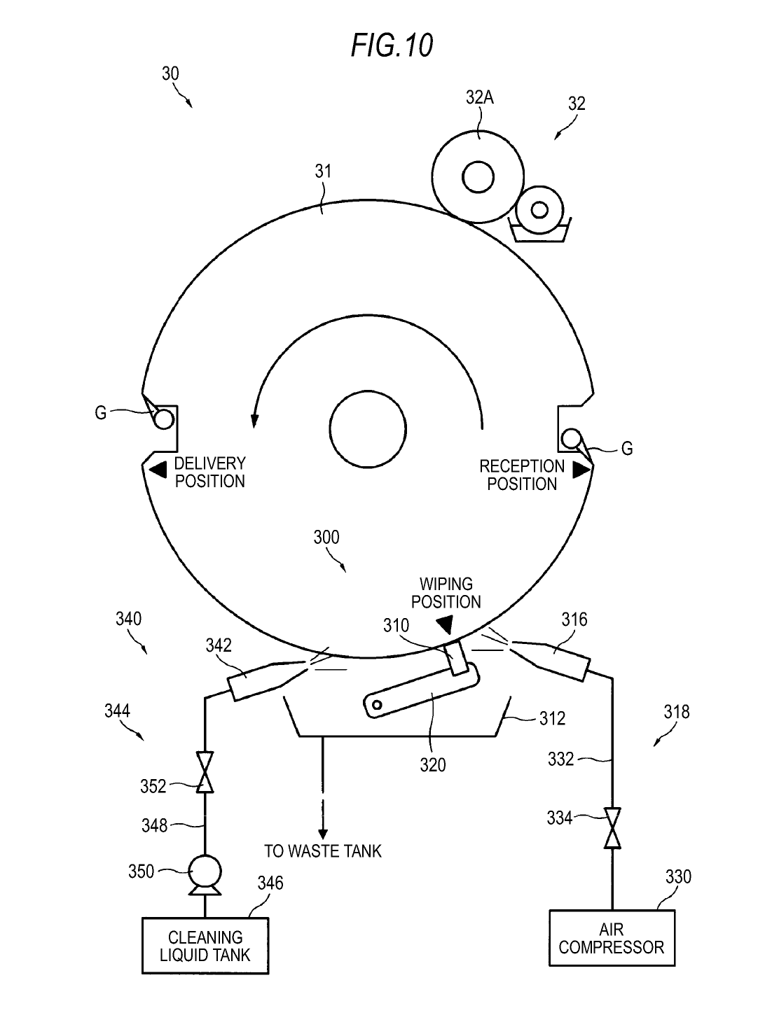

FIG. 10 is a schematic configuration diagram of a second embodiment of the process liquid coating portion.

As shown in FIGS. 10, the process liquid coating portion of the present embodiment is different from that of the first embodiment mentioned above that the process liquid coating portion of the present embodiment includes a cleaning liquid giving unit 340 (cleaning liquid giving part) that applies the process liquid coating drum 31 the cleaning liquid. Thus, only a configuration of the cleaning liquid giving unit 340 will be described herein.

The cleaning liquid giving unit 340 mainly includes cleaning liquid nozzles 342 that eject the cleaning liquid, and a cleaning liquid supplying device 344 that supplies the cleaning liquid nozzles 342 with the cleaning liquid.

The cleaning liquid nozzles 342 are formed corresponding to the width of the process liquid coating drum 31 like the air nozzle 316. That is, the cleaning liquid nozzles 342 are formed so that they can supply the cleaning liquid over the overall width of the process liquid coating drum 31.

The cleaning liquid nozzles 342 are provided at an upstream side (between the delivery position and the wiping position) of the blade 310 in the rotation direction of the process liquid coating drum 31 and eject the cleaning liquid toward the outer peripheral surface of the process liquid coating drum 31. That is, the cleaning liquid nozzles 342 are installed so that the cleaning liquid is supplied to the process liquid coating drum 31 before the wiping by the blade 310.

Furthermore, the cleaning liquid nozzles 342 are installed so as to supply the cleaning liquid to the upper portion of the collection dish 312. As a result, it is possible to collect the cleaning liquid dropping from the process liquid coating drum 31 by the collection dish 312.

The cleaning liquid supplying device 344 includes a cleaning liquid tank 346, a cleaning liquid supplying pipe 348, a cleaning liquid supplying pump 350, and a cleaning liquid valve 352.

The cleaning liquid ejected from the cleaning liquid nozzles 342 is stored in the cleaning liquid tank 346. For example pure water is used in the cleaning liquid. In addition, in the case of trying to further increase the cleaning effect, it is possible to use a surfactant contained in pure water.

The cleaning liquid supplying pipe 348 connects the cleaning liquid tank 346 with the cleaning liquid nozzle 342. The cleaning liquid stored in the cleaning liquid tank 346 is supplied to the cleaning liquid nozzles 342 via the cleaning liquid supplying pipe 348.

The cleaning liquid supplying pump 350 is installed in the middle of the cleaning liquid supplying pipe 348, and sends the cleaning liquid stored in the cleaning liquid tank 346 to the cleaning liquid nozzles 342.

The cleaning liquid valve 352 is installed in the middle of the cleaning liquid supplying pipe 348 and opens and closes the pipe line of the cleaning liquid supplying pipe 348.

The system controller 200 controls the driving of the cleaning liquid supplying pump 350 and the cleaning liquid valve 352, and controls the giving of the cleaning liquid to the process liquid coating drum 31. That is, in the case of giving the cleaning liquid, the cleaning liquid supplying pump 350 is driven by opening the cleaning liquid valve 352. As a result, the cleaning liquid stored in the cleaning liquid tank 346 is sent to the cleaning liquid nozzles 342, and the cleaning liquid is ejected from the cleaning liquid nozzles 342 toward the process liquid coating drum 31.

The cleaning liquid giving unit 340 is configured as above.

(Action)

When the coating process (the printing process) is started, the air supplying device 318 is driven, and the air is ejected from the air nozzles 316. The air is ejected toward the wiping position (a position with which the blade 310 comes into contact) of the process liquid coating drum 31.

Furthermore, the cleaning liquid supplying device 344 is driven together with the driving of the air supplying device 318, whereby the cleaning liquid is ejected from the cleaning liquid nozzle 342. The cleaning liquid is ejected toward the process liquid coating drum 31 at the upstream side of the blade 310. As a result, the cleaning liquid is supplied to the process liquid coating drum 31 before the wiping.

The cleaning liquid is supplied to the process liquid coating drum 31, whereby the blade 310 becomes wet, which can also effectively remove dirt particles or the like. Furthermore, the degradation of the blade 310 can also be prevented.

Meanwhile, when giving the process liquid coating drum 31 the cleaning liquid to wipe the process liquid coating drum 31 by the blade 310, the process liquid or the like easily remains when separating the blade 310.

However, in the process liquid coating portion of the present embodiment, since the air is ejected toward the wiping position of the blade 310, even when separating the blade 310, the remaining process liquid or the like can be removed without generating the liquid stagnation.

In this manner, according to the process liquid coating portion of the present embodiment, by supplying the cleaning liquid to perform the wiping, the process liquid can more effectively be removed.

### Third Embodiment

(Configuration)

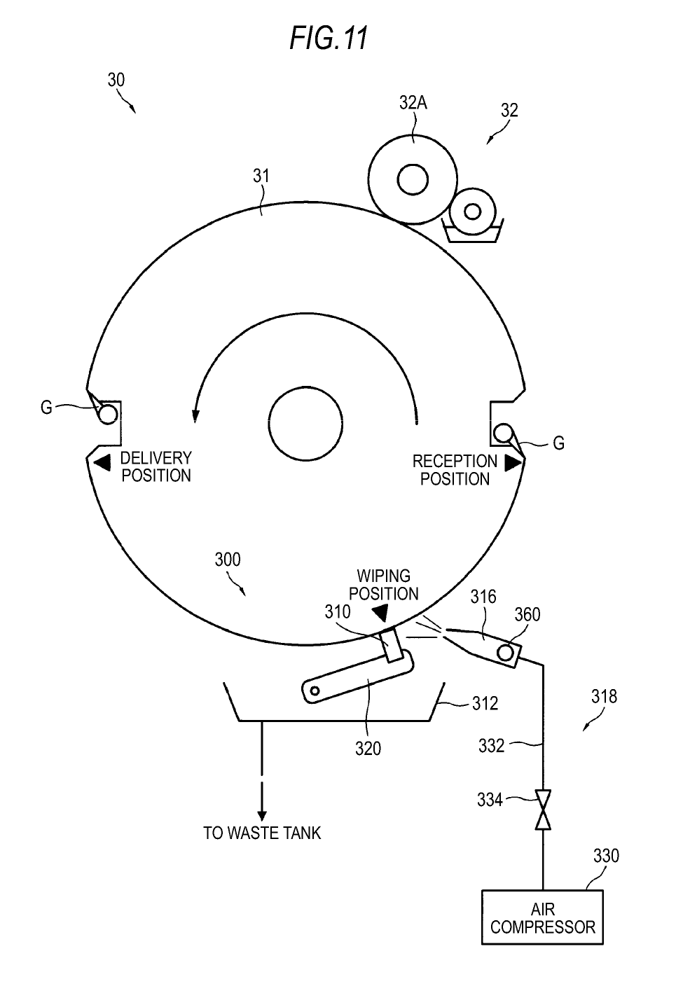

FIG. 11 is a schematic configuration diagram of a third embodiment of the process liquid coating portion.

As shown in FIG. 11, the process liquid coating portion of the present embodiment is different from that of the first embodiment that the hot wind is ejected from the air nozzles. Thus, only a configuration for ejecting the hot wind will be described herein.

As shown in FIG. 11, a heater 360 is installed inside the air nozzle 316. The heater 360 is constituted by, for example, an infrared heater. Air supplied from the air supplying device 318 is heated by the heater 360 and is blown from the outlet. Thus, the hot wind is blown and hit on the process liquid coating drum 31.

(Action)

When the coating process (the printing process) is started, the air supplying device 318 is driven, and air is ejected from the air nozzle 316. Furthermore, at the same time, the heater 360 is driven. As a result, the heated air is ejected from the air nozzles 316, and the hot wind is blown and hit on the process liquid coating drum 31.

The process liquid attached to the process liquid coating drum 31 is mainly removed from the blade 310. However, since the blade 3 10 is separated from the installation portion of the gripper G, in some cases, the process liquid may remain in the separated portion. The process liquid remaining in the process liquid coating drum 31 is removed by air ejected from the air nozzle 316.

Since the air is heated, for example, even in a case where there is a fine droplet incapable of being blown down by wind power, the fine droplet can be removed by the drying.

In this manner, in the process liquid coating portion of the present embodiment, the heated air is blown and hit on the process liquid coating drum 31 as the hot wind, thereby removing the remaining process liquid or the like. As a result, the process liquid or the like can more effectively be removed.

In addition, the temperature of air to be heated is set to an optimal numerical value by a test or the like, but it is preferable to set the temperature in the range of 40 to 70° C. (more, preferably, 50 to 60° C.).

Furthermore, in the present embodiment, a configuration has been adopted in which the heater is installed in the air nozzle 316 to heat air blown from the air nozzles 316, but the configuration blowing the heated air (the hot wind) is not limited thereto. For example, it is also possible to adopt a configuration may be adopted in which the heater is installed in the middle of the air supplying pipe 332 to heat the air blown from the air nozzles 316.

Furthermore, like the process liquid coating portion of the second embodiment, the cleaning liquid giving unit can also be installed in the process liquid coating portion of the present embodiment. As a result, it is possible to more effectively clean the process liquid coating drum 31.

### Fourth Embodiment

(Configuration)

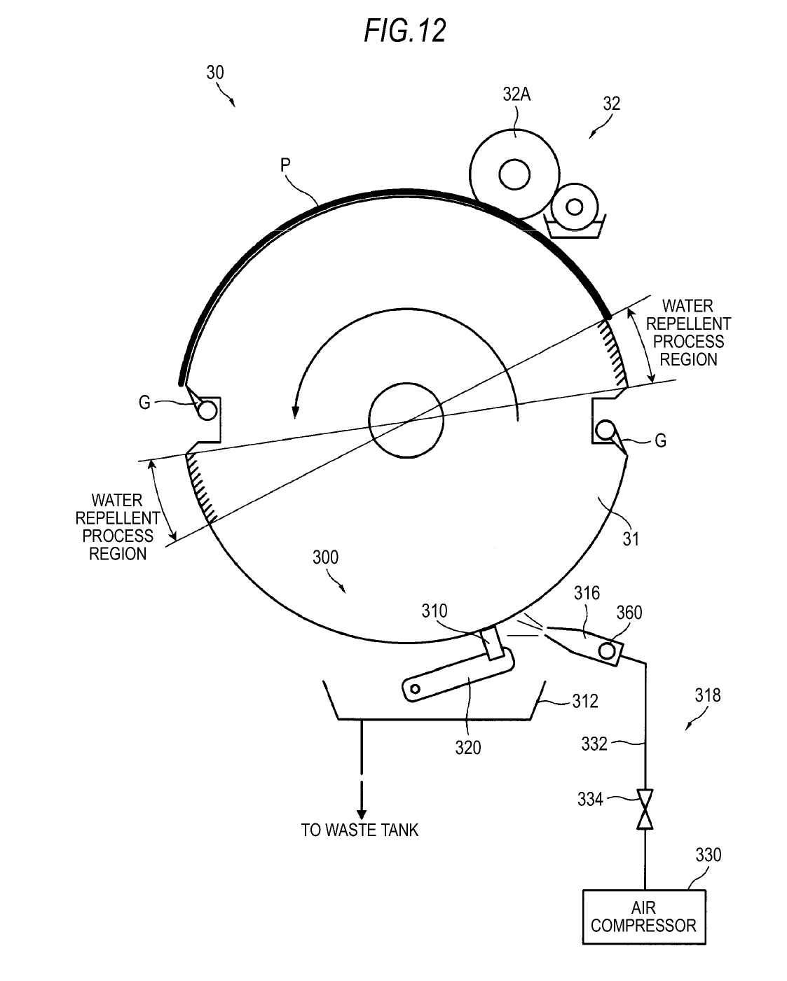

FIG. 12 is a schematic configuration diagram of a fourth embodiment of the process liquid coating portion.

As shown in FIG. 12, in the process liquid coating portion of the present embodiment, a water repellent process is performed on the outer peripheral surface of the process liquid coating drum 31.

The water repellent process is performed at least in a portion separating the blade 310. As a result, it is possible to effectively blow down the remaining process liquid when separating the blade.

The water repellent process is performed by coating the surface of the process liquid coating drum 31, for example, by PTFE (polytetrafluoroethylene, so-called Teflon (registered trademark).

(Action)

According to the process liquid coating portion of the present embodiment, the water repellent process is performed on the outer peripheral surface of the process liquid coating drum 31. As a result, it is possible to more easily remove the process liquid or the like when removing the same remaining in the process liquid coating drum 31 upon separating the blade 310.

In addition, as mentioned above, the residue of the process liquid or the like becomes an issue in the portion where the blade 310 is separated, and thus, the water repellent process may be performed at least in the portion where the blade 310 is separated. However, in order to more effectively remove the residual process liquid, as shown in FIG. 12, it is preferable to perform the water repellent process in a region from the rear end position of the paper P to the installation position of the gripper G when transporting the paper P of a minimum size.

In addition, the configuration of the process liquid coating drum of the present embodiment can also be coated to the process liquid coating drum of the second and third embodiments.

### Fifth Embodiment

(Configuration)

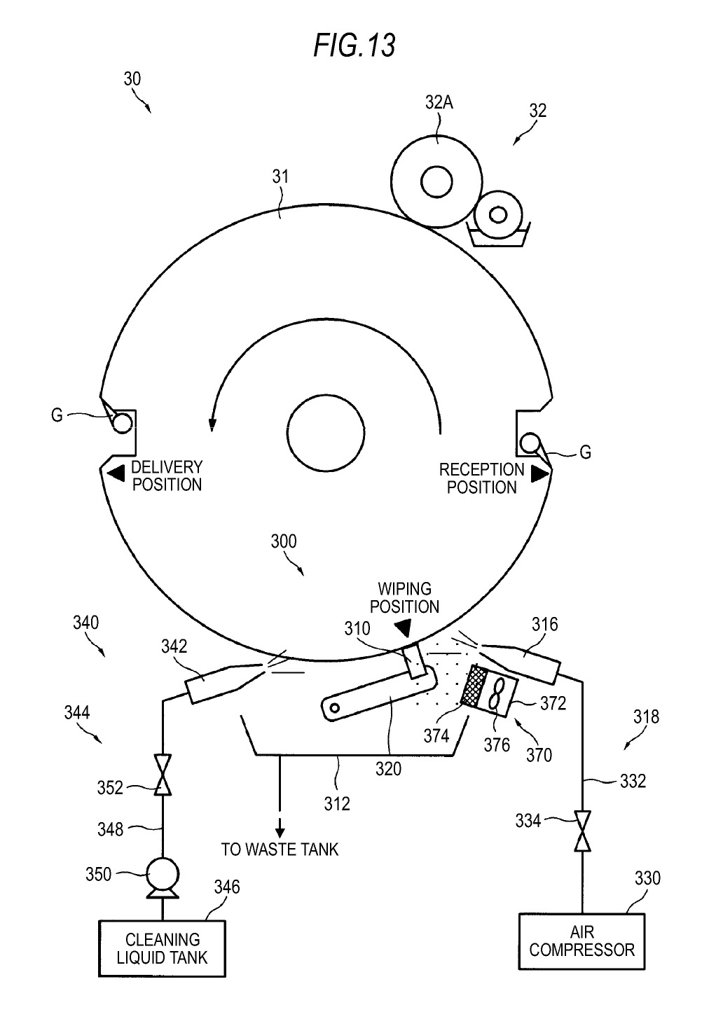

FIG. 13 is a schematic configuration diagram of a fifth embodiment of the process liquid coating portion.

As shown in FIG. 13, the process liquid coating portion of the present embodiment is different from that of the first embodiment that a mist collection device 370 (mist collection part) is included. Thus, only the configuration of the mist collection device 370 will be described herein.

The mist collection device 370 collects the mist generated by ejecting air to the process liquid coating drum 31. The mist collection device 370 mainly includes a housing 372, a filter 374, and a fan 376.

The housing 372 is formed corresponding to the width of the process liquid coating drum 31. A front portion of the housing 372 is formed with an inlet port. Furthermore, an exhaust duct (not shown) is connected to the housing 372.

The filter 374 is attached to the inlet port of the housing 372.

The fan 376 is installed inside the housing 372 and is driven by a motor (not shown).

The mist collection device 370 is configured as mentioned above. When driving the fan 376, the air is sucked from the inlet port of the housing 372, and the mist floating in the air is captured through the filter 374.

As mentioned above, the mist collection device 370 is installed for the purpose of collecting the mist generated by ejecting the air. Thus, the installation position thereof is installed in a position where the mist can most effectively be collected. Thus, the mist collection device is installed near a position (the wiping position) where the air is blown and hit from the air nozzles 316.

(Action)

The process liquid or the like remaining in the process liquid coating drum 31 when separating the blade 310 is removed by the air ejected from the air nozzle 316.

At this time, the air is blown and hit on the peripheral surface of the process liquid coating drum 31, whereby the mist may be generated. The mist generated by the ejection of the air is collected by the mist collection device 370. As a result, the process liquid coating drum 31 can be cleaned without scattering the dirt or the like therearound.

In addition, in the example mentioned above, the mist collection device 370 is installed in only one location, but the mist collection devices 370 may be installed in plural locations.

Furthermore, the mist collection device 370 of the present example can also be installed in the process liquid coating portion of the second to fourth embodiments.

### Other Embodiments

In the series of embodiments mentioned above, a case has been described where the present invention is coated to the recording device which prints a general-purpose printing paper using a water-based ink, but the coating of the present invention is not limited thereto. The present invention can similarly be coated to an apparatus which records on a medium other than the general-purpose printing paper by an inkjet method. Furthermore, the present invention can similarly be coated to a recording device which performs the printing using ink other than the water-based ink.

Furthermore, in the embodiments mentioned above, an example has been described in which the process liquid coating unit coats the process liquid by the roller, but the present invention can also be coated to a case of coating the process liquid by another method. For example, the present invention can similarly be coated to a case of coating the process liquid by the inkjet head like the image recording portion, a case of coating the process liquid by a spray or the like.

What is claimed is:

1. A coating device which coats liquid to a surface of a sheet of a medium, comprising:
a transport part having a drum, a gripping part for gripping a tip of the medium on an outer peripheral surface of the drum, and a drum rotation driving part for rotating the drum, wherein the transporting part transports the medium along a predetermined transport path by gripping the tip of the medium with the gripping part and then by rotating the drum;
a coating part for coating the liquid to the surface of the medium that is transported by the transport part;
a blade which comes into contact with an outer peripheral surface of the drum in a region other than the transport region and removes the liquid remaining on the outer peripheral surface of the drum;
a collection part for collecting the liquid removed from the drum by the blade;
a blade advance and retreat driving part for moving the blade back and forth to the drum and bringing the blade into contact with the outer peripheral surface of the drum or separates the blade from the outer peripheral surface of the drum;
a blowing part placed in a rear end of the blade in a rotation direction of the drum, blows air toward the drum, and blows down the liquid remaining on the outer peripheral surface of the drum to the collection part when the blade is separated; and
a control part for executing a coating process by controlling the operation of the transport part and the coating part, and executes a drum cleaning process by controlling the blade advance and retreat driving part and the blowing part.

2. The coating device according to claim 1,
wherein the blowing part blows the air from a downstream side of the rotation direction of the drum toward an upstream side thereof, and blows the air at a blowing angle of 30 to 70°.

3. The coating device according to claim 1, further comprising:
an air heating part for heating the air blown from the blowing part, wherein the air blowing part blows the air heated by the air heating part.

4. The coating device according to claim 2, further comprising:
an air heating part for heating the air blown from the blowing part, wherein the air blowing part blows the air heated by the air heating part.

5. The coating device according to claim 1, further comprising:
a cleaning liquid giving part placed in a front end of the blade in the rotation direction of the drum and coats the drum a cleaning liquid.

6. The coating device according to claim 2, further comprising:
a cleaning liquid giving part placed in a front end of the blade in the rotation direction of the drum and coats the drum a cleaning liquid.

7. The coating device according to claim 3, further comprising:
a cleaning liquid giving part placed in a front end of the blade in the rotation direction of the drum and coats the drum a cleaning liquid.

8. The coating device according to claim 4, further comprising:
a cleaning liquid giving part placed in a front end of the blade in the rotation direction of the drum and coats the drum a cleaning liquid.

9. The coating device according to claim 1, further comprising:
a mist collection part for collecting the mist near a position where the air is blown and hit on the drum.

10. The coating device according to claim 2, further comprising:
a mist collection part for collecting the mist near a position where the air is blown and hit on the drum.

11. The coating device according to claim 3, further comprising:
a mist collection part for collecting the mist near a position where the air is blown and hit on the drum.

12. The coating device according to claim 4, further comprising:
a mist collection part for collecting the mist near a position where the air is blown and hit on the drum.

13. The coating device according to claim 5, further comprising:
a mist collection part for collecting the mist near a position where the air is blown and hit on the drum.

14. The coating device according to claim 6, further comprising:
a mist collection part for collecting the mist near a position where the air is blown and hit on the drum.

15. The coating device according to claim 1,
wherein, on the outer peripheral surface of the drum, a water repellent process is performed at least in a portion in which the blade is separated.

16. The coating device according to claim 1,
wherein the control part always executes a drum cleaning process during execution of the coating process.

17. The coating device according to claim 1,
wherein the control part executes the drum cleaning process before starting the coating process.

18. The coating device according to claim 1,
wherein the control part executes the drum cleaning process after finishing the coating process.

19. The coating device according to claim 1,
wherein the control part executes the drum cleaning process before starting the coating process and/or after finishing the coating process, and executes only the blowing by the blowing part during execution of the coating process.

20. An inkjet recording device comprising:
the coating device according to claim 1;
a second transport part for receiving a medium with liquid coated to a surface thereof by the coating device and transports the medium along a predetermined transport path; and
an inkjet head for discharging ink droplets onto the surface of the medium to be transported by the second transport part to record an image.
